(19) United States
(12) Patent Application Publication
(10) Pub. No.: US 2006/0024615 A1
(43) Pub. Date: Feb. 2, 2006

(54) Optical recording medium

(75) Inventors: Takashi Horai, Tokyo (JP); Hiroshi Take, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/189,792

(22) Filed: Jul. 27, 2005

(30) Foreign Application Priority Data
Jul. 28, 2004 (JP) 2004-219608

(51) Int. Cl. G11B 7/24

(52) U.S. Cl. 430/270.19; 430/270.21; 430/945; 428/64.8; 369/288

(57) ABSTRACT

An optical recording medium includes a recording layer containing a cyanine dye and a quencher and a light transmittance reducing section for reducing the transmission of ultraviolet rays to the recording layer, and the light transmittance reducing section is composed of at least one of a substrate and a function layer. When the component ratio of the quencher to the total number of moles of the cyanine dye and the quencher is shown by A and the transmittance of ultraviolet rays of the light transmittance reducing section is shown by B, the component ratio A and the transmittance B are defined to satisfy the following mathematical formulas (1) and (2). With this arrangement, the optical recording medium can execute recording at a high linear speed while securing sufficient light stability.
0.3≧A≧−(B+0.075)/1.25 (1)
0.3≧B≧0.05 (2)

### BACKGROUND OF THE INVENTION

1. Field of the Invention

The present invention related to an optical recording medium using a dye in a recording layer, and more particularly, to an optical recording medium capable of executing recording at high speed.

2. Description of the Related Art

In this type of optical recording mediums (for example, DVD-R), it is known that data can be recorded at high speed as well as recording can be executed with a relatively low degree of modulation even if the recording is executed by a high output laser beam by forming a recording layer using a cyanine dye as a main component. In contrast, it is also known that the recording layer formed using the cyanine dye as the main component is defective in that it is liable to be changed by natural light (in particular, ultraviolet rays contained in natural light), and it is also known that the recording layer is formed by containing a quencher (light stabilizer) in it together with the cyanine dye as disclosed in, for example, the pamphlet of International Publication No. 01/062853.

The inventors have found the following problems to be solved as a result of examination of the recording layer containing the quencher disclosed in the above publication. That is, in recent years, optical recording mediums (DVD-R and the like) that can record information at a linear speed eight times faster than the linear speed (3.49 m/s) of the basic specification of DVD have been developed and commercially available. However, lately, DVD-R that can execute recording at a linear speed faster than eight times (linear speed exceeding eight times that of the basic specification) is desired. To more increase the linear speed in the recording layer disclosed in the publication, however, the component ratio of the cyanine dye as the main component must be more increased. However, an increase in the component ratio of the cyanine dye decreases the component ratio of the quencher, from which a problem arises in that sufficient light stability (light resistance) cannot be secured. Accordingly, a problem arises in that it is difficult to execute recording at a high linear speed exceeding eight times that of the basic specification while securing sufficient light stability by the arrangement in which the quencher is simply contained in the recording layer formed using the cyanine dye as the main component.

### SUMMARY OF THE INVENTION

A main object of the present invention, which was made in view of the above problems, is to provide an optical recording medium that can execute recording at a high linear speed while securing sufficient light stability.

To achieve the above object, the optical recording medium of the present invention includes a recording layer containing a cyanine dye as a main component as well as containing a quencher as a sub-component and a light transmittance reducing section for reducing the transmission of ultraviolet rays to the recording layer. It should be noted that, in the present invention, the light transmittance reducing section may be composed of at least one of a substrate, a function layer, and a sheet having only a function as the light transmittance reducing section, and the like, all of which are disposed on a laser beam incident side with respect to the recording layer.

The optical recording medium includes the recording layer containing the cyanine dye as the main component as well as containing the quencher as the sub-component and the light transmittance reducing section for reducing the transmission of ultraviolet rays to the recording layer. Accordingly, the optical recording medium can sufficiently enhance the light stability in such a degree as to satisfy the standard of the light stability while permitting recording at a high linear speed that is a feature of the recording layer using the cyanine dye as the main component because the light transmittance reducing section reduces the amount of irradiation of ultraviolet rays to the recording layer.

In this case, the light transmittance reducing section may be composed of at least one of the substrate and the function layer which are both disposed on the laser beam incident side with respect to the recording layer. With this arrangement, the optical recording medium can be made simply at an inexpensive cost as compared with an optical recording medium in which a light transmittance reducing section is arranged by a sheet having only a function for reducing light transmittance. This is because, in the optical recording medium, the substrate and the function layer, which have intrinsic functions other than the light transmittance reducing function, are additionally provided with the light transmittance reducing function.

Further, when the component ratio of the quencher to the total number of moles of the cyanine dye and the quencher is shown by A and the transmittance of ultraviolet rays of the light transmittance reducing section is shown by B, the component ratio A and the transmittance B may be defined to satisfy the following mathematical formulas (1) and (2).
0.3≧A≧−(B+0.075)/1.25 (1)
0.3≧B≧0.05 (2)

With the above setting, there can be securely realized the optical recording medium that can record information at a high linear speed and moreover has light stability sufficient to satisfy a setting.

It is preferable that the residual ratio of the quencher be 80% or more after the quencher receives xenon light of 4M lux for one hour. The light stability of the cyanine dye can be secured for a long period of time by using the above quencher. As a result, the optical recording medium having higher light stability can be realized.

It should be noted that the present invention relates to the subject contained in Japanese Patent Application No. 2004-219608 filed on Jul. 28, 2004, which is hereby explicitly incorporated as reference.

### BRIEF DESCRIPTION OF THE DRAWINGS

These and other objects and features of the present invention will be explained in more detail below with reference to the attached drawings, wherein:

FIG. 1 is a graph showing the possible combinations of the component ratio of a quencher contained in a recording layer and the transmittance of ultraviolet rays in a substrate;

FIG. 2 is a cross-sectional view showing the arrangement of an optical recording medium (DVD-R); and

FIG. 3 is a table showing the result of evaluation of samples made as embodiments 1 to 4 and samples made as comparative examples 3 and 4.

### DESCRIPTION OF THE PREFERRED EMBODIMENTS

A best mode of an optical recording medium of the present invention will be explained below with reference to the accompanying drawings.

The optical recording medium according to the present invention includes a recording layer that contains a cyanine dye as a main component as well as contains a quencher (light stabilizer) as a sub-component as well as reduces the transmission of ultraviolet rays to the recording layer by a substrate (light transmittance reducing section) disposed on the incident side of a laser beam with respect to the recording layer.

In this case, the light stability of the cyanine dye can be enhanced by containing the quencher, and, as a result, the light stability of the recording layer can be also enhanced. However, the characteristics (characteristics capable of executing recording at high linear speed) of the recording layer containing the cyanine dye as the main component are gradually deteriorated as the content of the quencher increases. Accordingly, the component ratio of the quencher to the total number of moles of the cyanine dye and the quencher in the recording layer is restricted to 30 mol % or less so that the optical recording medium is provided with electric characteristics defined by the standard even at a linear speed exceeding eight times (for example, linear speed of 16 times). Although the light stabilization of the optical recording medium is enhanced by containing the quencher, the optical recording medium in which the component ratio of the quencher is restricted to 30 mol % or less, the optical recording medium cannot be provided with the light stability defined by the standard. To cope with this problem, an ultraviolet ray absorbent is contained in (is dispersed in and mixed with) the substrate so that the ultraviolet ray absorbent absorbs a part of the ultraviolet rays (specifically, ultraviolet rays having a wavelength of 375 nm) incident on the recording layer from the outside, thereby the amount of transmittance (amount of irradiation) of the ultraviolet rays to the recording layer is restricted to 30 mol % or less. As a result, the recording layer can be provided with the light stability defined by the standard. In contrast, the light stability of the optical recording medium is deteriorated as the component ratio of the quencher is gradually reduced from 30 mol %. Accordingly, to compensate the deterioration of the light stability, it is preferable to reduce the transmittance of ultraviolet rays in the substrate in proportion to the reduction of the component ratio of the quencher from 30 mol %. In this case, there is a possibility that the strength of the substrate is gradually reduced as the content of the ultraviolet ray absorbent in the substrate is increased to reduce the transmittance of the ultraviolet rays. Further, as the transmittance of the ultraviolet rays having the wavelength of 375 nm is reduced, the transmittance of light having a wavelength somewhat larger or smaller than 375 nm is also reduced. Accordingly, there is a possibility that the transmittance of a recording/reproducing laser beam is also reduced. Accordingly, to prevent the reduction of transmittance of the recording/reproducing laser beam while securing sufficient strength of the substrate, it is preferable to define the content of the ultraviolet ray absorbent in the substrate to an amount by which the transmittance of the ultraviolet rays in the substrate is made to 5% or more.

From what has been described above, when the component ratio of the quencher to the total number of moles of the cyanine dye and the quencher is shown by A and the transmittance of ultraviolet rays to the substrate is shown by B, it is preferable to define the component ratio A and the transmittance B to satisfy the following mathematical formulas (1) and (2).
0.3≧A≧−(B+0.075)/1.25 (1)
0.3≧B≧0.05 (2)

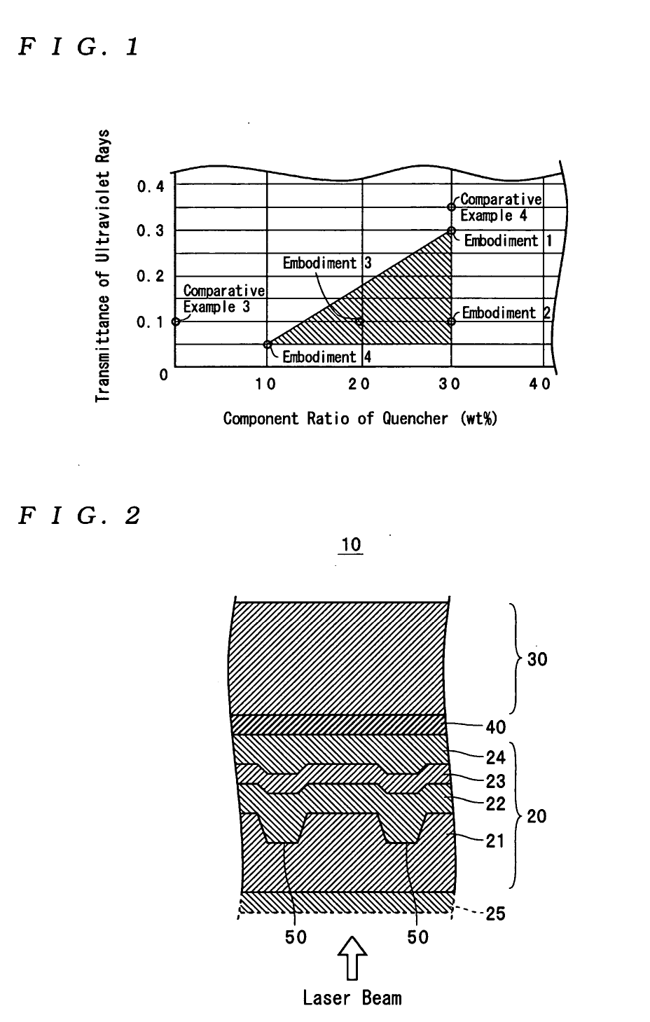

FIG. 1 shows the region, in which the quencher component ratio A and the ultraviolet ray transmittance B can be combined so as to satisfy the formulas (1) and (2), by slanting lines. When the recording layer is arranged by defining (selecting) the quencher component ratio A and the ultraviolet ray transmittance B so that they are included in the region with the slanting lines, it is possible to secure sufficient light stability while recording information at a high linear speed (linear speed exceeding eight times).

Further, it is preferable that the cyanine dye is a dye having a cyanine structure shown by, for example, the following general chemical formula (I) to execute recording at the high linear speed.

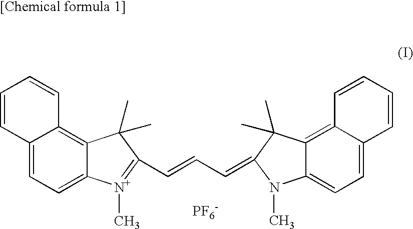

In contrast, it is preferable to use a singlet oxygen quencher, which has a residual ratio of 80% or more when it is arranged as a simple body in a thin film state of 80-100 nm, as the quencher. The residual ratio used here means the residual ratio of the quencher after it is exposed to (receives) xenon light of 4M lux for one hour using a xenon lamp that is in conformity with ISO-105-B02. The light stability of the cyanine dye can be secured for a long period by using the quencher having the high residual ratio as described above. Further, at least one kind of, for example, an azo metal complex shown in the following general chemical formula (II), a bis-phenylendithiol complex shown in the following general chemical formula (III), aminium salt shown in the following general chemical formula (IV), and a formazan complex shown in the following general chemical formula (V) may be employed as the quencher. It should be noted that the two complexes of the azo metal complex and the bis-phenylendithiol complex may be also used as a salt forming body with the cyanine dye. In this case, the number of moles of the cyanine dye of the cation site of the quencher is calculated as that of the cyanine dye. When, for example, the cyanine dye has 60 moles and the quencher, which forms salt with the cyanine dye, has 40 moles, since the cyanine dye has 60+40=100 mol %, the component ratio of the quencher is 40/(100+40)×100=28.6 mol %.

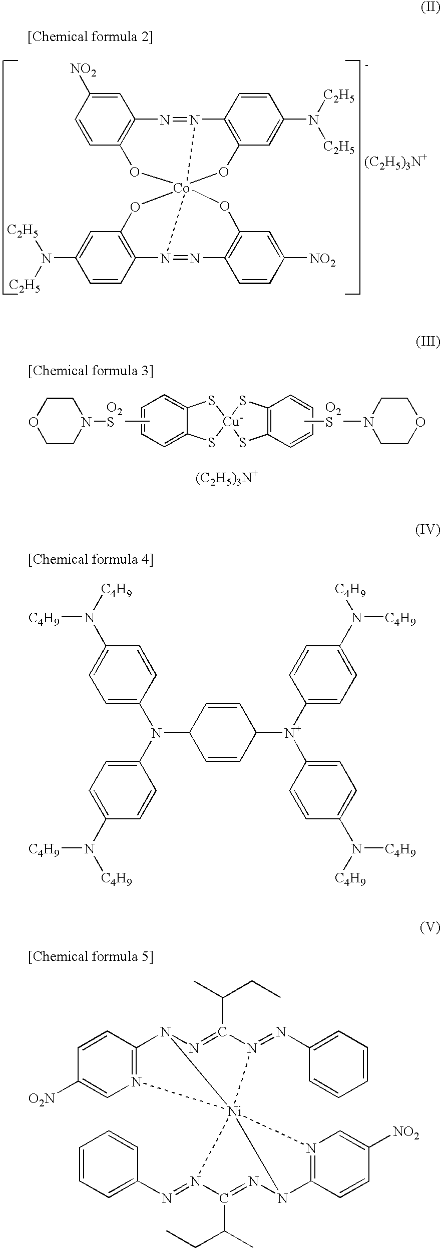

Abenzotriazol compound, a yellow anthraquinone compound, or the like shown in, for example, the following general chemical formula (VI) may be employed as the ultraviolet ray absorbent contained in the substrate. The transmittance of ultraviolet rays may be defined to any arbitrary value less than 30% by adjusting the content of the benzotriazol compound, the yellow anthraquinone compound, or the like.

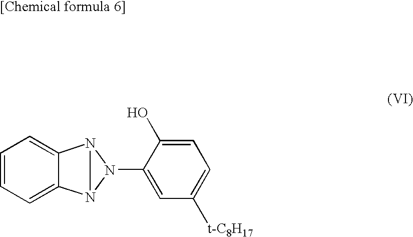

In the optical recording medium, the recording layer contains the cyanine dye as the main component as well as contains the quencher as the sub-component, and the transmission of ultraviolet rays to the recording layer is restricted by the substrate disposed on the incident side of the laser beam with respect to the recording layer. As a result, according to the optical recording medium, the light stability thereof can be enhanced to such a degree as to satisfy the standard of the light stability by making it possible to execute recording at a high linear speed, which is a feature of the recording layer containing the cyanine dye as the main component, by enhancing the light stability of the recording layer by containing the quencher in the range by which by the feature can be maintained, and by reducing the amount of ultraviolet rays irradiated to the recording layer by suppressing the ultraviolet rays passing through the substrate by causing the substrate to contain the ultraviolet ray absorbent as to the light stability which cannot be sufficiently secured only by containing the quencher. Accordingly, there can be securely realized the optical recording medium that can record information at a high linear speed and moreover has light stability sufficient to satisfy the standard by defining the component ratio of the quencher to the total number of moles of the cyanine dye and the quencher to satisfy the formulas (1) and (2) and by defining the transmittance of ultraviolet rays to the substrate. Further, since the quencher whose residual ratio as the simple body is 80% or more after it is exposed to xenon light is used, the light stability of the cyanine dye can be secured for a long period, thereby the optical recording medium having higher light stability can be realized. Further, since the substrate and the function layer are provided with the function for reducing the light transmittance, the optical recording medium can be simply arranged at an inexpensive cost.

### Embodiments

Next, the present invention will be explained in detail with reference to embodiments.

First, the basic arrangement of the optical recording medium used in the embodiments will be explained with reference to FIG. 2. The optical recording medium 10 is an optical recording medium corresponding to the DVD-R standard and composed of a disc 20 and a disc 30 (dummy substrate) bonded to each other by an adhesive 40, wherein the disc 20 can execute recording. In this case, the disc 20 is arranged by sequentially laminating a recording layer 22, a reflection layer 23, and a protection layer 24 on a substrate 21 on which grooves 50 are formed.

The substrate 21 is composed of, for example, polycarbonate resin and formed in a thickness of about 0.6 mm. Further, the substrate 21 contains an ultraviolet ray absorbent. The disc 30 is composed of, for example, polycarbonate resin. An arbitrary material such as ultraviolet ray curing resin, thermosetting resin, or the like may be selected as the material of the adhesive 40, and an adhesive layer composed of the adhesive 40 is formed in a thickness of about 10 μm to 200 μm. It should be noted that the substrate 21 and the disc 30 may be composed of a material selected from various types of thermoplastic resin such as acrylic resin, amorphous polyolefin, TPX, polystyrene resin, and the like in place of the polycarbonate resin and further the substrate 21 and the disc 30 may be composed of glass.

The recording layer 22 contains a cyanine dye as a main component as well as contains a quencher as a sub-component. Further, the recording layer 22 is formed in a thickness of 30 nm to 300 nm. The reflection layer 23 is composed of a material such as high reflectance metal, for example, Au, Cu, Al, Ag, AgCu, and the like or an alloy. The reflection layer 23 is preferably formed in a thickness of 50 nm or more by vapor deposition, sputtering, and the like. The protection layer 24 is formed in a thickness of 0.5 μm to 100 μm using various types of resin materials, for example, ultraviolet ray curing resin and the like.

When information is recorded or additionally recorded to the optical recording medium 10, a recording laser beam is irradiated to the recording layer 22 through the substrate 21. At the time, the reflectance of the recording layer 22 is changed at the irradiated portion thereof, thereby the information is recorded.

Next, a test method and an evaluation method of the optical recording medium employed in the embodiment will be explained.

First, prior to a test, the respective samples of embodiments 1 to 4 of an optical recording medium which has the same arrangement as that of the optical recording medium 10 and whose quencher component ratio A and ultraviolet ray transmittance B are included in the region shown with the slanting lines in FIG. 1. Specifically, a sample, in which the respective component ratios of the cyanine dye and the quencher in the recording layer were defined to 70 mol % and 30 mol %, respectively as well as the transmittance of ultraviolet rays in the substrate 21 was defined to 30%, was made as the embodiment 1. Likewise, a sample, in which the respective component ratios of the cyanine dye and the quencher in the recording layer were defined to 70 mol % and 30 mol %, respectively as well as the transmittance of ultraviolet rays in the substrate 21 was defined to 10%, was made as the embodiment 2. Further, a sample, in which the respective component ratios of the cyanine dye and the quencher in the recording layer were defined to 80 mol % and 20 mol %, respectively as well as the transmittance of ultraviolet rays in the substrate 21 was defined to 10%, was made as the embodiment 3. Further, a sample, in which the respective component ratios of the cyanine dye and the quencher in the recording layer were defined to 90 mol % and 10 mol %, respectively as well as the transmittance of ultraviolet rays in the substrate 21 was defined to 5%, was made as the embodiment 4.

In contrast, a sample, in which the respective component ratios of the cyanine dye and the quencher in the recording layer were defined to 70 mol % and 30 mol %, respectively as well as no ultraviolet ray absorbent was contained in the substrate 21, was made as a comparative example 1. Likewise, a sample, in which the respective component ratios of the cyanine dye and the quencher in the recording layer were defined to 40 mol % and 60 mol %, respectively as well as no ultraviolet ray absorbent was contained in the substrate 21, was made as a comparative example 2. Further, a sample, in which the component ratio of the cyanine dye in the recording layer was defined to 100 mol % as well as the transmittance of ultraviolet rays in the substrate 21 was defined to 10%, was made as a comparative example 3. Further, a sample, in which the respective component ratios of the cyanine dye and the quencher in the recording layer were defined to 70 mol % and 30 mol %, respectively as well as the transmittance of ultraviolet rays in the substrate 21 was defined to 35%, was made as a comparative example 4. FIG. 1 shows the relation between the quencher component ratio A and the ultraviolet ray transmittance B of the comparative examples 3 and 4 likewise that of the embodiments 1 to 4.

In this case, the respective samples were made by adjusting the film thickness of the recording film so that a degree of signal modulation was defined to 60% or more at a linear speed of 3.49 m/s (one time speed). Further, the azo metal complex shown in the above general chemical formula (II) was used as the quencher, and the benzotriazol compound shown by the general chemical formula (VI) was used as the ultraviolet ray absorbent. It should be noted that the residual ratio of the azo metal complex used was 95%.

As an experiment method of the electric characteristics of the respective samples, as to a bottom jitter, an optical disc drive device model “DDU-1000” (made by Pulsetec Industrial Co. Ltd., wavelength: 661 nm, NA: 0.60) was used, information was recorded on the recording layers 22 of the respective samples at a linear speed of 3.49 m/s (one time speed) and a linear speed of 55.84 m/s (16 times speed), and the recorded information was reproduced by the same device. Further, as to an PI error, the information recorded at the respective linear speeds was reproduced using the optical disc drive device model “DDU-1000” at a linear speed of 3.49 m/s and measured using a DVD decoder “DR-3340” (made by Kenwood). Further, as to an experiment method of light stability of the respective samples, first, information was recorded on the recording layers 22 of the samples by the same method as that described above, and xenon light of 4M lux for one hour was irradiated to the samples from the side of the substrates 21 using a xenon lamp that was in conformity with ISO-105-B02. Next, the IP error of the respective samples, to which the xenon light was irradiated, was measured by the same experiment method as that used to measure the electric characteristics as described above.

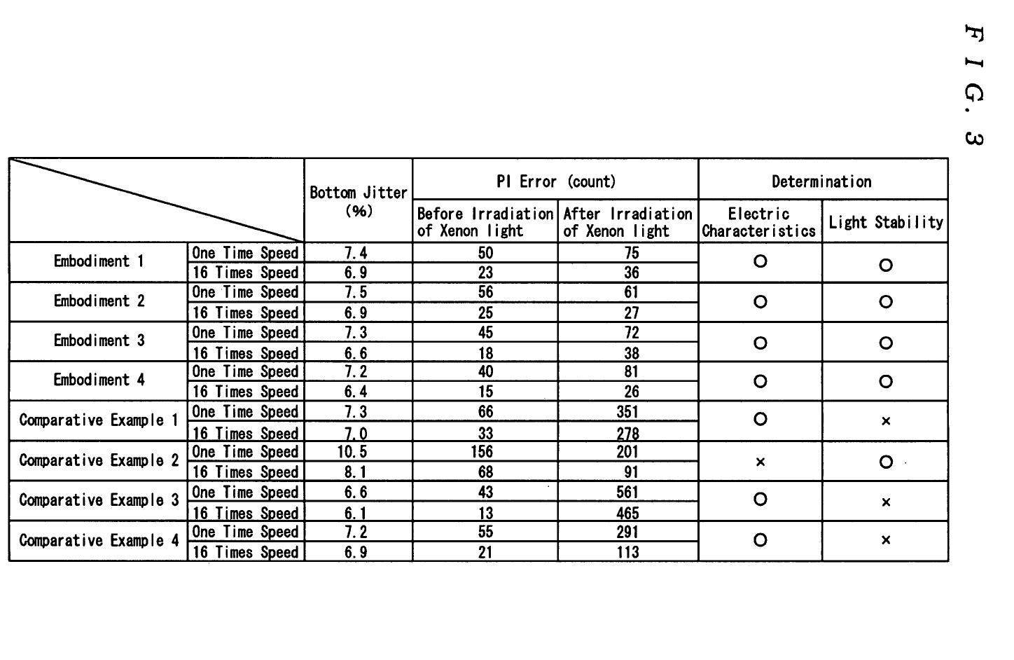

As an evaluation method of the electric characteristics of the respective samples, the measured bottom jitters and PI errors were compared with the standards of the bottom jitter (less than 8%) and the PI error (less than 280 counts) defined by the DVD-R standard, and when the bottom jitter values were 8% or less at any of linear speeds of 3.49 m/s and 55.84 m/s as well as when the error count values of the maximum PI errors of 8ECC blocks were less than 280 at the time the samples were not irradiated by xenon light, they were evaluated good (o), and they were evaluated bad (x) in the cases other than the above cases. As an evaluation method of the light stability of the respective samples, the PI errors measured in the respective samples after they were irradiated by the xenon light were compared with the standard of the error PI defined by the DVD-R standard, and when the number of error counts of the maximum PI errors of the 8ECC blocks were less than 280, the samples were evaluated good (o), and they were evaluated bad (x) in the cases other than the above cases. FIG. 3 shows a result of the evaluations.

It could be confirmed from FIG. 3 that the optical recording mediums (respective embodiments 1 to 4), in which the cyanine dye component ratio A and the ultraviolet ray transmittance B to the substrate 21 satisfied the formulas (1) and (2), had excellent electric characteristics and optical stability that sufficiently satisfy the DVD-R standard.

In contrast, it could be confirmed that the light stability of the comparative example 1, in which although the recording layer was formed using the same component ratio as that of the embodiments 1 and 2, the substrate 21 contained no ultraviolet ray absorbent, had a bad evaluation for the light stability because the amount of transmission (amount of irradiation) of ultraviolet rays to the recording layer 22 was more increased than the embodiments 1 and 2, although the embodiment 1 had a good evaluation for the electric characteristics. Further, in the comparative example 2, in which no ultraviolet ray absorbent was contained in the substrate 21 while enhancing the light stability by much more increasing the component ratio of the quencher than the embodiments 1 and 2, it could be confirmed that the evaluation for the electric characteristics was bad because the component ratio of the cyanine dye was reduced, although the evaluation for the light stability was good. Further, in the comparative example 3, in which the transmittance of ultraviolet rays was restricted to 10% by containing the ultraviolet ray absorbent in the substrate 21 without containing the quencher at all, it could be confirmed that the evaluation for the light stability was bad because the light stability was deteriorated due to the non-existence of the quencher, although the evaluation for the electric characteristics was good. Further, in the comparative example 4, in which the recording layer was formed using the same component ratio as the embodiments 1 and 2 as well as the transmittance of ultraviolet rays was somewhat increased to 35% by somewhat reducing the content of the ultraviolet ray absorbent in the substrate 21, it could be confirmed that the evaluation for the light stability was bad because the amount of transmittance (amount of irradiation) of ultraviolet rays to the recording layer 22 was increased by that the transmittance of ultraviolet rays to the substrate 21 was somewhat increased, although the evaluation for the electric characteristics was good.

It should be noted that the present invention is by no means limited to the above arrangement. For example, although the arrangement example, in which the amount of transmission of ultraviolet rays to the recording layer 22 was adjusted by containing the ultraviolet ray absorbent in the substrate 21, is described above. However, there may be employed, for example, an arrangement in which a function layer 25 (light transmittance reducing section) for absorbing ultraviolet rays is disposed at a position acting as a laser beam incident side with respect to the recording layer 22 as shown by a broken line of FIG. 2 so that the ultraviolet rays irradiated to the recording layer 22 is restricted by the substrate 21 and the function layer 25. In this case, the overall transmittance of ultraviolet rays of both the substrate 21 and the function layer 25 is defined so as to satisfy the mathematical formulas (1) and (2). It should be noted that although FIG. 2 shows the arrangement example in which the function layer 25 is disposed on the surface of the substrate 21 on the laser beam incident side thereof, a function layer (not shown) acting as the light transmittance reducing section for absorbing ultraviolet rays may be disposed at any arbitrary position between the surface of the optical recording medium on the laser beam incident side thereof and the recording layer 22. Further, an arrangement, in which no ultraviolet ray absorbent is contained in the substrate 21, may be also employed by more increasing the transmittance of ultraviolet rays in the function layer 25. In this case, the transmittance of ultraviolet rays of the function layer 25 is defined so as to satisfy the formulas (1) and (2). Further, a hard coat layer having characteristics of wear resistance and the like may be employed as the function layer, and the ultraviolet ray absorbent may be contained in the hard coat layer. When the hard coat layer is composed of ultraviolet ray curing resin, a reaction initiator, which absorbs ultraviolet rays by being decomposed and changed to yellow by the ultraviolet rays, may be used as a reaction initiator. Further, it is more preferable to contain a sensitizer as the ultraviolet ray absorbent.

Further, it is needless to say that the present invention may be applied to a so-called double-sided optical recording medium in which a recording layer and a reflection layer are separately formed and bonded with each other.

What is claimed is:

1. An optical recording medium comprising:
a recording layer containing a cyanine dye as a main component as well as containing a quencher as a sub-component; and
a light transmittance reducing section for reducing the transmission of ultraviolet rays to the recording layer.

2. An optical recording medium according to claim 1,
wherein the light transmittance reducing section comprises at least one of a substrate and a function layer disposed on a laser beam incident side with respect to the recording layer.

3. An optical recording medium according to claim 1,
wherein when the component ratio of the quencher to the total number of moles of the cyanine dye and the quencher is shown by A and the transmittance of ultraviolet rays of the light transmittance reducing section is shown by B, the component ratio A and the transmittance B are defined to satisfy the following mathematical formulas (1) and (2).
0.3≧A≧−(B+0.075)/1.25 (1)
0.3≧B≧0.05 (2)

4. An optical recording medium according to claim 2,
wherein when the component ratio of the quencher to the total number of moles of the cyanine dye and the quencher is shown by A and the transmittance of ultraviolet rays of the light transmittance reducing section is shown by B, the component ratio A and the transmittance B are defined to satisfy the following mathematical formulas (1) and (2).
0.3≧A≧−(B+0.075)/1.25 (1)
0.3≧B≧0.05 (2)

5. An optical recording medium according to claim 1,
wherein the residual ratio of the quencher is 80% or more after the quencher receives xenon light of 4M lux for one hour.

6. An optical recording medium according to claim 2,
wherein the residual ratio of the quencher is 80% or more after the quencher receives xenon light of 4M lux for one hour.

7. An optical recording medium according to claim 3,
wherein the residual ratio of the quencher is 80% or more after the quencher receives xenon light of 4M lux for one hour.

8. An optical recording medium according to claim 4,
wherein the residual ratio of the quencher is 80% or more after the quencher receives xenon light of 4M lux for one hour.
